(19) United States
(12) Patent Application Publication
(10) Pub. No.: US 2002/0114451 A1
(43) Pub. Date: Aug. 22, 2002

(54) Variable width block cipher

(76) Inventor: Richard Satterfield, Wellesley, MA (US)

Correspondence Address: CESARI AND MCKENNA, LLP, 88 BLACK FALCON AVENUE, BOSTON, MA, 02210, US

(21) Appl. No.: 09/899,355

(22) Filed: Jul. 5, 2001

Related U.S. Application Data
(60) Provisional application No. 60/216,072, filed on Jul. 6, 2000.

(51) Int. Cl. H04L 9/06

(52) U.S. Cl. 380/37; 380/29

(57) ABSTRACT

A variable with block cipher using plaintext elements and masking array elements which are sometimes converted into digits in another number base. Binary bytes or digits are modified by binary rotating, shuffling of byte sequence and arithmetic/logic modification using masking arrays. For recovery of the plaintext, the ciphertext elements and masking array elements are sometimes converted again into digits and a reverse combination of rotating, shuffling and arithmetic/logic operations results in the original plaintext elements.

### CROSS-REFERENCE TO RELATED APPLICATIONS

The present application claims priority from U.S. Provisional Patent Application Serial. No. 60/216,072, which was filed on Jul. 6, 2000, by the same inventor and with the same title as the present invention, and which Provisional Application is hereby incorporated by reference.

This patent application is also closely related to pending U.S. patent application Ser. Nos. 09/019,915 and 09/019,916, and issued U.S. Pat. No. 5,717,760.

### BACKGROUND OF THE INVENTION

1. Field of the Invention

The present invention relates to apparatus and methods for encryption and decryption wherein a ciphertext is generated. More particularly, the present invention is related to the use of symmetric private key encryption. Once the sender and receiver have exchanged key information, encryption of a message by the sender and decryption by the receiver is accomplished in a direct manner.

2. Background Information

Dr. Man Young Rhee, in his book “Cryptography and Secure Communications” (McGraw-Hill, 1994) states on page 12: “A cryptosystem which can resist any cryptanalytic attack, no matter how much computation is allowed is said to be unconditionally secure. The one time pad is the only unconditionally secure cipher in use. One of the most remarkable ciphers is the one-time pad in which the ciphertext is the bit-by-bit modulo-2 sum of the plaintext and a nonrepeating keystream of the same length. However, the one-time pad is impractical for most applications because of the large size of the nonrepeating key.”

U.S. Pat. No. 4,751,733 entitled “SUBSTITUTION PERMUTATION ENCIPHERING DEVICE” describes in the abstract: “A substitution-permutation enciphering device. This device, adapted for transforming a binary word into another binary word, by succession of substitutions and permutations, under the control of a key . . . ” teaches away from the scheme described herein. The use of a substitution memory as described by U.S. Pat. No. 4,751,733 has a limitation in that this patent discloses and teaches changes only to the bits of a byte.

U.S. Pat. No. 5,001,753 entitled “CRYPTOGRAPHIC SYSTEM AND PROCESS AND ITS APPLICATION” describes the use of a rotational operator in an accumulator. The rotation operation is used to cause an accumulator bit to be temporarily stored in the carry bit, rather than in a memory location, and the carry bit (regardless of its value) is ultimately rotated back into its original position. The rotate operation is explained in detail by column 3 line 61 through column 4 line 6. Also described is the processing within a microprocessor using an eight bit (1 byte) accumulator. The ′753 patent is limited to the rotate operation in conjunction with an accumulator.

U.S. Pat. No. 5,113,444, entitled “RANDOM CODING CIPHER SYSTEM AND METHODS,” and U.S. Pat. No. 5,307,412, teach the use of a thesaurus and/or synonyms; together with arithmetic/logic operations to combine data and masks to accomplish encoding/decoding. These patents are thus limited by the use of the thesaurus and synonyms.

U.S. Pat. No. 5,412,729 entitled “DEVICE AND METHOD FOR DATA ENCRYPTION” introduces the concept of using matrix operations to multiplex the bytes in the cleartext so that a byte in the ciphertext may contain elements of more than one cleartext bytes. The patent teaches about the multiple use of a data element to create a ciphertext element. This is different from the combination of: creating a single working element by concatenating several bytes together (with permutation of sequence during the concatenation), binary rotating the resultant single element, and the breaking up the single element back into multiple bytes to be placed in an output buffer (also with permutation of sequence). Under certain conditions, a matrix presentation may be used to represent the effect of the rotation operation. However, careful examination will show that the matrix representation of the rotation operation does not follow the rules associated with a linear system and thus is quite different from this patent. This patent method is limited by teaching the multiplexes several different data elements together wherein each element may be used more than once, while the scheme herein only modifies a single data element at any one time.

U.S. Pat. No. 5,077,793 entitled “RESIDUE NUMBER ENCRYPTION AND DECRYPTION SYSTEM” teaches (column 3 lines 40 to column 4 lines 8): “If the moduli are chosen to be mutually prime, then all integers with the range of zero to the product of the moduli minus one can be uniquely represented. The importance of the residue number system to numerical process is that the operations of addition, subtraction, and multiplication can be performed without the use of carry operations between the moduli. In other words, each digit in the n-tuple can be operated on independently and in parallel.” And shows that for the sum Z of the digits X and Y, the ith digit may be given by: zᵢ=(xᵢ+yᵢ) mod mᵢ and that “a sixteen bit binary number can be represented in the residue number system using five moduli 5,7,11,13,17.” The moduli (mᵢ) are chosen to be relatively prime to each other. In Columns 5 and 6 the description goes on to define Z=(X+Y) mod M (where M is ,lf5 the product of all of the moduli, i.e., M=m₁×M₂ . . . mₙ,) as a generalization of the Vigenere cipher. If Z=(X−Y) mod M is used to encrypt X using Y then X may be recovered from Z by X=(Y−Z) mod M, which is a generalization of the Beaufort cipher.

Pages 305 and 306 in “Applied Cryptography, Second Edition” by Bruce Schneier, John Wiley & Sons, Inc. 1996—describe the Madryga encryption method. “The Madryga trio consists of two nested cycles. The outer cycles repeats eight time (although this could be increased if security warrants) and consists of an application of the inner cycle to the plaintext. The inner cycle transforms plaintext to ciphertext and repeats once for each 8-bit block (byte) of the plaintext. Thus the algorithm passes through the entire plaintext eight successive times. An iteration of the inner cycle operates on a 3-byte window of data, called the working frame [figure reference omitted]. This window advances 1 byte for each iteration. (The data are considered circular when dealing with the last 2 bytes.) The first 2 bytes of the working frame are together rotated a variable number of positions, while the last byte is XORed with some key bits. As the working frame advances, all bytes are successively rotated and XORed with key material. Successive rotations overlap the results of a previous XOR and rotation, and the data from the XOR is used to influence the rotation. This makes the entire process reversible. Because every byte of data influences the 2 bytes to its left and the 1 byte to its right, after eight passes every byte of the ciphertext is dependent upon 16 bytes to the left and 8 bytes to the right. When encrypting, each iteration of the inner cycle starts the working frame at the next-to-last byte of the plaintext and advances circularly through to the third-to-last byte of the plaintext. First, the entire key is XORed with a random constant and then rotated to the left 3 bits. The low-order 3 bits of the low-order byte of the working frame are saved; they will control the rotation of the other 2 bytes. Then, the low-order byte of the working frame is XORed with the low-order byte of the key. Next, the concatenation of the 2 high-order bytes are rotated to the left the variable number of bits (0 to 7). Finally, the working frame is shifted to the right 1 byte and the whole process repeats.” On page 306, “Both the key and the 2 ciphertext bytes are shifted to the right. And the XOR is done before the rotations.” The Madryga method may be improved upon by a better randomizing of the order of the bytes prior to concatenation and by not storing the rotate distance information (even though it is encrypted) in the data itself. A weakness of this method is that the order of the bytes prior to concatenation is unmodified and therefore more easily broken.

U.S. Pat. No. 5,113,444, entitled “RANDOM CODING CIPHER SYSTEM AND METHODS” and U.S. Pat. No. 5,307,412, teach the use of a thesaurus and/or synonyms, together with arithmetic/logic operations to combine data and masks to accomplish encoding/decoding. These patents are thus limited by the use of the thesaurus and synonyms.

Pages 13 through 15 in “Applied Cryptography, Second Edition”by Bruce Schneier, John Wiley & Sons, Inc. 1996, provide a critique on the security inherent in the Vigenere encryption method. “The simple-XOR algorithm is really an embarrassment; it's nothing more than a Vigenere polyalphabetic cipher.” “There is no real security here. This kind of encryption is trivial to break, even without computers. It will take only a few seconds with ,a computer. Assume the plaintext is English. Furthermore, assume the key length is any small number of bytes. Here's how to break it:

1. Discover the length of the key by a procedure known as counting coincidences. XOR the ciphertext against itself shifted various number of bytes, and count those bytes that are equal. If the displacement is a multiple of the key length, then something over 6 percent of the bytes will be equal. If it is not, then less than 0.4 percent will be equal (assuming a random key encrypting normal ASCII text; other plaintext will have different numbers). This is called the index of coincidence. The smallest displacement that indicates a multiple of the key length is the length of the key.

2. Shift the ciphertext by that length and XOR it with itself. This removes the key and leaves you with the plaintext XORed with the plaintext shifted then length of the key. Since English has 1.3 bits of real information per byte, there is plenty of redundancy for determining a unique decryption.”

The above method for breaking a Vigenere cipher relies on the fact that XOR (base 2) is its own inverse and that the encrypting key (masking bytes) are repeated many times. The XOR is its own inverse because A XOR B XOR B=A. It is an object of the present invention to improve upon the security of the Vigenere and Variant Beaufort cipher methods by applying them not to characters directly but rather to digits representing that character in another number base.

Pages 70 and 71 in “Cryptography: An Introduction to Computer Security” by Jennifer Seberry and Josef Pieprzyk, Prentice Hall, 1989—“The Vigenere cipher. The key is specified by a sequence of letters: K=k₁ . . . k_{d} where kᵢ, (i=1, . . . ,d) gives the amount of shift, in the ith alphabet, that is: fᵢ(a)=a+kᵢ (mod n).” “Variant Beaufort cipher. Here we use: fᵢ(a)=(a−kᵢ) (mod n). Since a−kᵢ=a+(n−kᵢ) (mod n) the Variant Beaufort cipher is equivalent to the Vigenere cipher with the key character n−kᵢ. The Variant Beaufort cipher is, in fact, the inverse of the Vigenere cipher since if one is used to encipher the other is used to decipher.”

Historically the Vigenere and Variant Beaufort ciphers have been applied to whole letters or characters. That is, the value (position in the alphabet) of a character has a number either added or subtracted to it (modulo the length of the alphabet) and the resultant number is used to specify a character position in the alphabet and the character at that position is sent as the ciphered character.

Herein BCN refers to the binary to base n conversion of a number and the representation of the base n number as a digit shown in binary. A common example (base 10) is BCD (binary coded decimal) where the values 0 through 9 are represented by 4 binary bits.

Herein a byte is defined as two or more bits. In typical usage a byte is considered to be, but is not limited to, eight bits.

Herein, arrays (or masks) are described as being comprised of elements. Such elements are defined as any actual or logical grouping, for example: a bit, a nibble, a byte or word of any length.

It is an object of the present invention to provide an encryption/decryption apparatus and method that does not depend upon the use of thesaurus's and/or synonyms tables.

It is yet another object of the present invention to provide an encryption/decryption scheme wherein the presentation of a character in one number base is transformed into a corresponding representation in another number base.

### SUMMARY OF THE INVENTION

The foregoing objects are met in an encryption/decryption apparatus where a message or information expressed as elements or characters is to be encrypted from transmission or sending to another where the message will be decrypted using variable width block encoding. A set of masks of elements or characters are defined and utilized in the encryption/decryption. The message elements and mask elements are used in a binary form or may be converted into corresponding elements in another new number base system, where this new number base system is not binary. The converted message and mask elements are combined, element by element, respectively, thus forming a new set of elements which are defined as a ciphertext. This ciphertext may be sent or transformed into a set of elements in yet another number base that is suitable for transmission.

The foregoing objects are met in an encryption apparatus and method providing masking arrays, a byte concatenator, a barrel shifter, a byte sequence shuffler and an optional decatenator which encrypt and decrypt input data. Encoding or Decoding will consist of one or more passes through a cleartext message using the encryption mechanism described herein.

To decode the ciphertext, the same mask elements as used for encoding are combined, element by element, respectively using the inverse or reverse from that which was used for encryption, thus forming a new set of elements which when converted to a number in the original message number base is the plaintext message.

Herein XORn (XOR+ and XOR−) describes a modified exclusive-or operation (base N1) defined as: let the numbers A and B base N1 and N2 respectively be defined (for m digits).

$$\begin{matrix}A = {\sum }_{i = 0}^{m - 1} N {1}^{i} {a}_{i} and & Eq . 1 \\ B = {\sum }_{i = 0}^{m - 1} N {2}^{i} {b}_{i} & Eq . 2\end{matrix}$$

Then, in a preferred embodiment, the elements A and B may be combined according to the following equations.

$$\begin{matrix}C = A XOR + B = {\sum }_{i = 0}^{m - 1} N {1}^{i} ( ( N 1 + {a}_{i} + {b}_{i} ) mod N1 ) and & Eq . 3 \\ C = A XOR - B = {\sum }_{i = 0}^{m - 1} N {1}^{i} ( ( W * N 1 + {a}_{i} - {b}_{i} ) mod N1 ) & Eq . 4\end{matrix}$$

where W is an integer large enough to keep the resultant sum a positive number. For base 2, XORn is identical to the standard XOR operation. The conversion of a binary number to j digits (base n) is done by the successive division of the number by n where the remainder of each division becomes the ith digit for i=0 to j−1. The digits of a number (base n) are converted back to binary by: setting sum=0, then for i=j−1 to 0 perform sum=(sum * n)+digits. When done the result is in sum.

An advantage of the present invention is that an encryption method employing an XOR (base 2) is strengthened by the use of a base greater than 2. This is because A XORn B XORn B does not equal A (where XORn is either XOR+ or XOR−only).

Another advantage of the present invention is that each byte to be encrypted and each masking byte (key byte) in a preferred embodiment are converted from binary into a string of digits or elements base n (n>2) and the operations of equation 1 and 2 are applied to these digits in a systematic manner. One or two number bases, or moduli, is used at a time.

In a preferred embodiment of the present invention the equations 3 and 4 are used to advantage since there is no repeating key (as a key is usually thought of) because the key is now the sequence of digits resulting from the conversion of binary masking bytes to digits of another number base. The masking byte string is now not limited to a few characters, but can be a very long series of bytes. Though it would still be possible to have a repeating series of digits if the masking bytes followed a repeating sequence, the ready availability of arbitrary masking bytes in the computer environment should lessen this occurrence. These bytes may be derived from any of several digital sources including, but not limited to, the sampling of digital sources, the application of numeric hashing functions, pseudo-random number generation and other numeric operations.

In a preferred embodiment the equation 3 is used for encryption and equation 4 is used for decryption. Since these are inverse ciphers, in another preferred embodiment equation 4 is used instead for encryption and equation 3 is used for decryption. For simplicity, only the first method is shown, but the implementation of the second scheme will be understood by anyone skilled in the art.

Arbitrary and random numbers are created by normal digital processes. Most digitized music which comes on a CD-ROM is 16 bits of Stereo sampled at a 44.1 kilohertz rate. This produces approximately 10.5 million bytes per minute. Of these about one half may be used as arbitrary data bytes, or about 5 million bytes per minute. Reasonably random data byte are generated by reading in the digital data stream which makes up the music and throwing away the top 8 bits and sampling only the lower eight bits of sound to produce an arbitrary or random number. Fourier analysis on the resultant byte stream shows no particular patterns. It should be kept in mind that silent passages are to be avoided. If taking every byte of music in order is undesirable, then using every nth byte should work quite well for small values of n between 11 and 17. Please note, the error correction inherent with a music CD-ROM is not perfect and the user might want to convert the CD-ROM music format to a WAVE (.WAV) file format and then send the WAVE (.WAV) file to someone by either modem, large capacity removable drive, digital magnetic tape cartridge, or by making a digital CD-ROM containing the WAVE (.WAV) file.

Another source of arbitrary or random digital numbers may be found in the pixel by pixel modification (exclusive-oring, adding, subtracting) of several pictures from a PHOTO CD-ROM, again looking at the low order bytes. Computer Zipped (.ZIP) files and other compressed file formats can be used.

The variable width block encoder described herein may itself be used as a generator of arbitrary bytes to be use with additional copies of this scheme or in other encrypting schemes.

Is The sender and receiver must agree ahead of time on the sources to be used for the masking bytes and how these sources will be sampled and/or combined to create the masking bytes to be used to encrypt and decrypt a message.

In other preferred embodiments, the intelligent sampling of digital sources can be used to advantage to lessen the reconstruction of the byte stream used for encryption. In addition, encryption and hashing algorithms may be used to modify the digital sources prior to their use. Moreover, the modification of pseudo-random numbers for tables, arrays and/or masks may also be used to advantage.

Other objects, features and advantages will be apparent from the following detailed description of preferred embodiments thereof taken in conjunction with the accompanying drawing.

### BRIEF DESCRIPTION OF THE DRAWINGS

FIG. 1. is a diagram of a Variable Width Block Cipher;

FIG. 1A is a diagram showing the handling of intermediate results within the variable with block cipher;

FIG. 2 are tables showing typical byte sources and addressing modes to be used for control and updating of masks, variable and counters;

FIG. 3 is a table listing the typical masks, variable, counters, sources, and pointers needed to a processing pass with a Cipher Block encoder;

FIG. 4 if a flow chart of the initialization procedure;

FIG. 5 is the first part of a flow chart showing the processing of a data file;

FIG. 5A is the second part of the flow chart showing processing of a data file;

FIG. 6 is a flowchart of the Rotate/Shuffle operation;

FIG. 7 is a flowchart of the Shuffle operation;

FIG. 8 is a flowchart of a multibyte binary rotate operation;

FIG. 9 is a flowchart of the Arithmetic/Logic operations;

FIG. 10 is a flowchart of the updating of a masking Array;

FIG. 11 is a flowchart showing the updating of a pointer and the retrieval of a new value for a variable or counter;

FIG. 11A is a flowchart showing the retrieving of a value from a source and pointer;

FIG. 12 is a diagram of a Variable Width Block Cipher with common masking arrays.

### DETAILED DESCRIPTION OF PREFERRED EMBODIMENTS

Data byte to be encrypted or decrypted are placed into an input I/O Buffer. Next a predetermined number of bytes are selected from the Input I/O Buffer with a permutation of sequence and concatenated together to form a single binary data element. This data element is modified by the scheme described herein and the resulting modified bytes are placed either directly into an output I/O Buffer or placed into the output I/O Buffer using a second permuted sequence. The number of bytes, which are concatenated together to form successive input data elements may be fixed or varied during the processing of an I/O Buffer. The width of the Block Cipher is adjusted so as to match the number of input bytes used to create the input data element. All internal arrays or byte strings are ordered so that the first element is the least significant byte of a number. The size of the masking elements M(1) through M(3) may be fixed or varied during processing but the mask elements must be at least the size of the data element to be encoded. The number of bytes, W, or width of a processing operation may be determined by table lookup, a formula, pseudorandom number generation, or by some combination thereof. It is up to the implementor to decide how the width will be specified. The Rotate/Shuffle mechanism when used along with a varied number of bytes to be processed, helps obscure the underlying permutation sequence used to create the data element processed by the block cipher.

In another preferred embodiment, not shown, the Block Cipher is used as a pseudorandom byte generator where the bytes generated are used by another encryption scheme to encode data. The bytes for this other scheme may come from any of: the masking arrays, intermediate processing results, the output data element, or some combination thereof.

ED is a global 1 bit flag, which specifies whether encryption (0) or decryption (1) is to be performed by the Block Cipher. ED is used as a flag to modify the Rotate/Shuffle and Arithmetic/Logic Operations. When ED=1, the direction of rotation is the opposite of what is directed by the value of RV(i) and the inverse of the arithmetic/logic operation as designated by AV(i) is used. Similarly, when ED=1, a inverse shuffle sequence is utilized as compared to when ED=0.

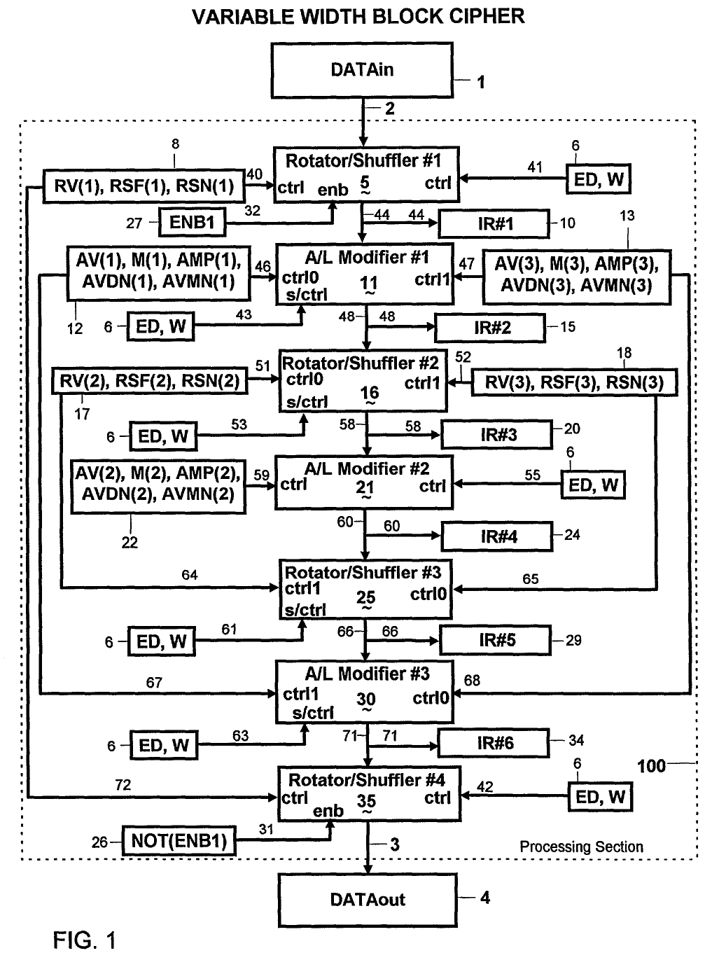

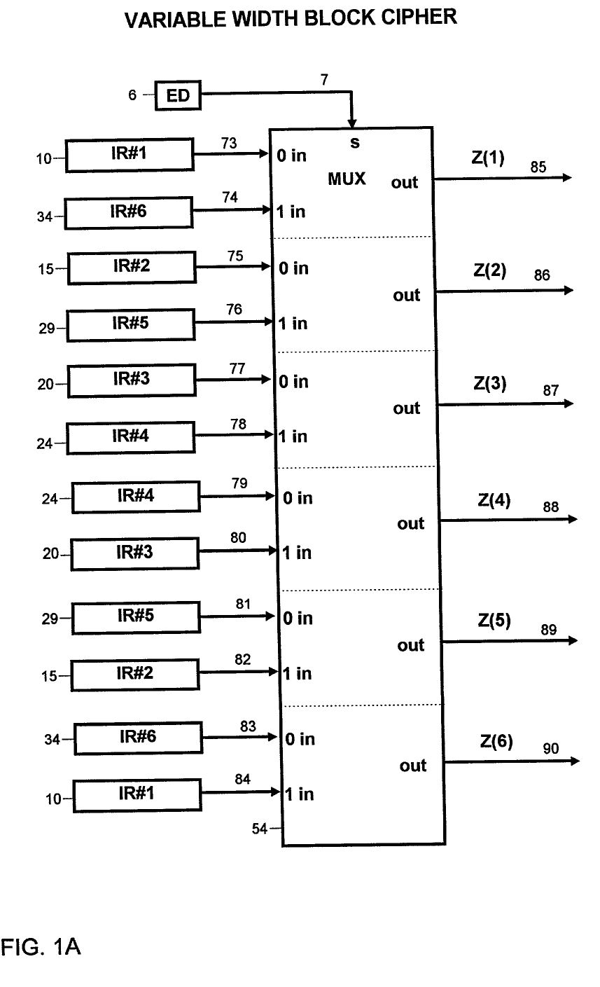

FIG. 1. shows a diagram of a variable width block cipher mechanism. For simplicity of the drawing, the two separate items, W and ED are shown together as item 10, but are individual items. W represents the Width or number of bytes to be contained in the input and output data element while ED is the encryption/decryption flag. The following tables shows the effects of the value of ED of the operation of the Block Cipher.

| CONTROL | | |
|---|---|---|
| INPUTS FOR | ED = 0 | ED = 1 |
| Rotator/Shuffler | ENB1, RV(1), RSF(1), RSN(1) | ENB1, RV(1), RSF(1), RSN(1) |
| #1 | | |
| A/L Modifier #1 | AV(1), M(1), AMP(1), | AV(3), M(3), AMP(3), AVDN(3), |
| | AVDN(1), AVMN(1) | AVMN(3) |
| Rotator/Shuffler | RV(2), RSF(2), RSN(2) | RV(3), RSF(3), RSN(3) |
| #2 | | |
| A/L Modifier #2 | AV(2), M(2), AMP(2), | AV(2), M(2), AMP(2), AVDN(2), |
| | AVDN(2), AVMN(2) | AVMN(2) |
| Rotator/Shuffler | RV(3), RSF(3), RSN(3) | RV(2), RSF(2), RSN(2) |
| #3 | | |
| A/L Modifier #3 | AV(3), M(3), AMP(3), | AV(1), M(1), AMP(1), AVDN(1), |
| | AVDN(3), AVMN(3) | AVMN(1) |
| Rotator/Shuffler | NOT(ENB1), RV(1), RSF(1), | NOT(ENB1), RV(1), RSF(1), |
| #4 | RSN(1) | RSN(1) |

The effect of the value of AV(1 to 3) when sent to the appropriate A/L Modifier:

| AV value | Operation Performed, ED = 0 | Operation Performed, ED = 1 |
|---|---|---|
| 0 | Input XOR Mask M | Input XOR Mask M |
| 1 | Input ADD Mask M | Input SUB Mask M |
| 2 | Input SUB Mask M | Input ADD Mask M |
| 3 | Input XOR Mask M | Input XOR Mask M |
| 4 | Input XOR− Mask M | Input XOR+ Mask M |
| 5 | Input XOR+ Mask M | Input XOR− Mask M |
| 6 | Input XOR− Mask M | Input XOR+ Mask M |
| 7 | Input XOR+ Mask M | Input XOR− Mask M |

When AV(i)>=4 then XOR− or XOR+ operations are performed. These consist of converting the input data element into digits using number base AVDN(i) and Eq. 1, and also converting the mask element M(i) into digits using number base AVDM(i) and Eq. 2. These digits are then combined using Eq. 3 or Eq. 4. and the resulting digits are recombined using number base AVDN(i) into a binary number which is the output of the A/L modifier. Mask M(i) is considered to be the lowest W bytes of M(i).

RSF(i) is the Rotate/Shuffle Flag and is used to designate whether a Rotate or Shuffleoperation will occur and whether the input will be treated as binary bits or as digits (base RSD(i) using Eq. 1). Again, when ED=1, the direction for rotate operation is reversed and the inverse of the shuffle operation is specified.

| RSF(i) value | Resulting DPF value and operation | Rotate or Shuffle |
|---|---|---|
| 0 | 0 = Binary | Rotate |
| 1 | 0 = Binary | Shuffle |
| 2 | 1 = Digits | Rotate |
| 3 | 1 = Digits | Shuffle |

Normally ENB1 equals NOT(ED). Therefore NOT(ENB1) equals ED. Another implementation, not shown, has the binary ENBL flag being set by an exterior user settable binary flag.

The size in bytes of the single data element to be encrypted or decrypted, DATAin 1, is designate by W. W and ED, 6, together go to all of the Rotate/shufflers and the A/L Modifiers to designate the number of bytes to be processed and whether encryption (ED=0) or decryption (ED=1) will occur. This data element, DATAin 1, is created by selecting bytes from the input I/O buffer and concatenating them together to form a single multibyte wide data element or item. DATAin, 1, is sent via 2 to Rotate/Shuffler #1, 5, where the W, 6, bytes of the data item are either rotated or shuffled as directed by ENB1, 27, [RV(1), RSF(1) and RSN(1)], 8. When ED=0 and ENB1=1, the Rotate/Shuffle operation is enabled. When ED=1, ENB1=0 and the Rotate/Shuffle #1 operation is disabled and the W bytes of the data item pass through unmodified to both IR#1, 10, and AIL Modifier #1, 11, via 44. At A/L Modifier #1, 11, the directions for the modification of the data item is are given by [AV(1), M(1), AMP(1), AVDN(1), AVMN(1)], 12, via 46 if ED=0 or by [AV(3), M(3), AMP(3), AVDN(3), AVMN(3)], 13, via 47 if ED=1. The modified data item then goes to both IR#2, 15, and Rotator/Shuffler #2, 16, via 48. The second Rotate/Shuffler #2, 16, is always enabled. When ED=0, [RV(2), RSF(2), RSN(2)], 17 via 51 control the operation if 16 else when ED=1, [RV(3), RSF(3), RSN(3)], 18, via 52 provide the control information concerning how the modified data item is further changed. The data item modified by A/L Modifier #2, 21, goes via 60 to IR#4, 24, and Rotate/Shuffler #3, 25. This rotate/shuffler is, always enabled. The data item is further modified by Rotate/Shuffler #3, 25 under the control of [ED, W], 6 via 61, and [RV(3), RSF(3), RSN(3)], 18 via 65, when ED=0 or [RV(2), RSF(2), RSN(2)], 17 via 64, when ED=1. The modified data item then goes via 66 to IR#5, 29, and A/L Modifier #3, 30. Here the data item is again modified under the direction and control of [AV(3), M(3), AMP(3), AVDN(3), AVMN(3)], 13 via 65, if ED=0, else when ED=1 then [AV(1), M(1), AMP(1), AVDN(1), AVMN(1)], 12 via 67, controls the modification. The resulting modified data item then goes via 71 to IR#6, 34, and Rotate/Shuffler #4, 35. If ED=0 then NOT(ENBI) is 0 and the rotate/shuffle operation is disabled and the data item on 71 goes unmodified via 3 to DATAout, 4. When ED=1, then NOT(ENB1)=1 and the data item is modified under the direction and control of [RV1, RSF(1), RSN1)], 8 via 72, and [ED, W], 6 via 42.

FIG 1A is a continuation diagram of FIG. 1. Here the intermediate Results IR#1 through IR#6 are directed to the temp outputs Z(1) through Z(6). The table below shows how the mux, 54, is controlled by the value of ED, 6 via 7.

| Z(i) | ED = 0 | ED = 1 |
|---|---|---|
| Z(1), 85 | IR#1, 10 via 73 | IR#6, 34, via 74 |
| Z(2), 86 | IR#2, 15 via 75 | IR#5, 29 via 76 |
| Z(3), 87 | IR#3, 20 via 77 | IR#4, 24 via 78 |
| Z(4), 88 | IR#4, 24 via 79 | IR#3, 20 via 80 |
| Z(5), 89 | IR#5, 29 via 81 | IR#2, 15 via 82 |
| Z(6), 90 | IR#6, 34 via 83 | IR#1, 10 via 84 |

As can be seen by inspection of the above table, the effect of ED=1 is to reverse the order of Intermediate Results being directed to the temp values Z. Thus when the Z's are used to calculate formulas for updating a variable, mask, counter or pointer the results will be the same for both encryption (ED=0) and decryption (ED=1).

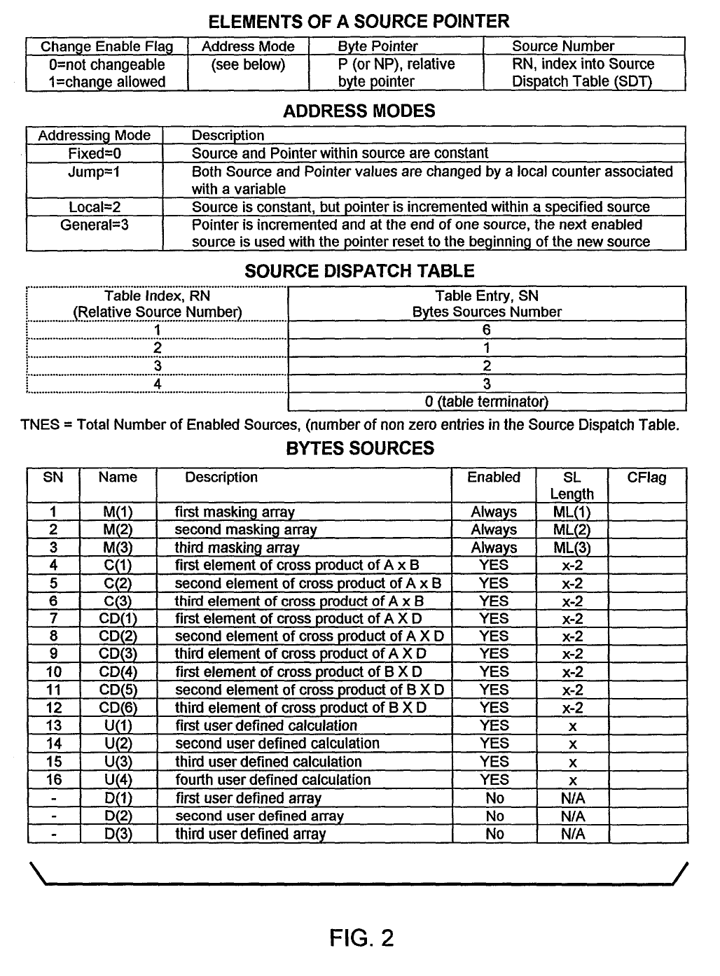

FIG. 2. shows the elements of a source pointer, pointer addressing modes and details for byte sources. If the six Z values are considered to be vectors A and B (each of three components) such that A₁=Z(1), A₂=Z(2), A₃=Z(3), B₁=Z(4), B₂=Z(5) and B₃=Z(6), then the cross products of A and B are:

Eq. 3 C(1)=A₂*B₃−B₂*A₃=Z(2)*Z(6)−Z(5)*Z(3)

Eq. 4. C(2)=A₃*B₁−B₃*A₁=Z(3)*Z(4)−Z(6)*Z(1)

Eq. 5 C(3)=A₁*B₂−B,*A₂=Z(1)*Z(5)−Z(4)*Z(2)

The calculations for CD(1) through CD(6) are similar to the above but user supplied values for D₁, D₂ and D₃ are substituted as indicated in the calculation of a cross product. Only the Lowest W bytes of M(1), M(2) and M(3) are used to modify a data item. While any of the bytes contained within these arrays may be used to update a variable, counter or pointer. To save time, only those sources or calculations required to update a variable, counter, etc. are performed as needed. An enabled source has an entry in the Source Dispatch Table, SDT.

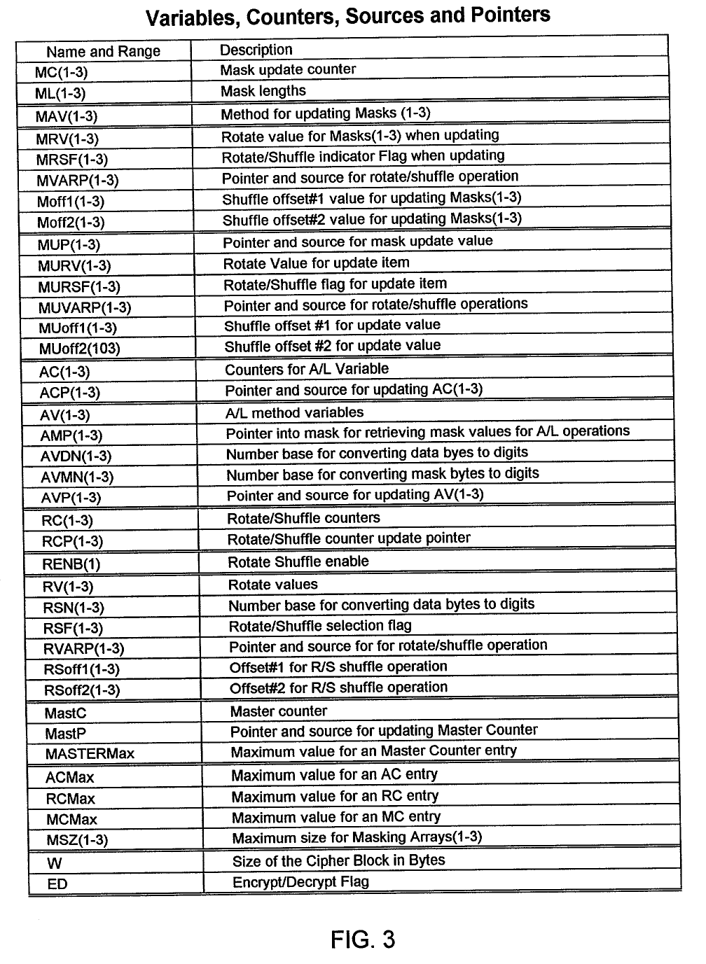

Each variable and counter has a pointer associated with it to specify how the counter and variable is updated. The pointer consists of several fields. The first field is a Change Enable flag field. When set to 0, no changes are allowed in the address pointer's other two fields. Otherwise when set to 1, the other three fields may be changed when a master counter (see FIG. 3) counts down to zero. The other three fields are Address Mode, Pointer Value (NP or P) and Relative Source Number (RN). There are four address modes which a pointer may utilize. They are Fixed, Jump, Local and General modes. In Fixed mode, the byte source and pointer values are constant. In Jump mode, both the source and pointer values are updated using retrieved or computed values. In Local mode the source is held constant, and the pointer is incremented and is reset to the beginning of a source when the end of a source is reached. In General mode, when the pointer reaches the end of a source, the pointer is reset to the beginning and the next eentry in the SDT is used. The third field is a byte pointer, relative to the start of the source, where bytes will be retrieved for updating a variable or counter. The fourth field is the Relative source Number, RN, which is used as an index into the Source Dispatch Table, SDT. Only those sources which have an entry into the SDT are updated. If a source has more than one entry in the SDT, it is updated only once. A source needing updating will have it's Cflag set equal to 1. And once the byte source has been updated the Cflag entry for that source is cleared to prevent a recalculation of the source if multiple SN entries exist within the SDT.

When a Master Counter is decremented to zero, the counter value is reset using its pointer and all other variables and counters are updated. Where the Change Enable Flag allows it a pointer value is also updated and byte sources are enabled or disabled depending upon the bit patterns of other bits retrieved using the master pointer. A Master Counter is provided for each processing pass to provide another degree of randomness to the encryption, decryption operation.

When a Byte Source is enabled, it's Source Number, SN, is entered in the Source Dispatch Table and TNES is changed to reflect the number of SN entries in the table. When a Source is disabled, its SN value is removed from the dispatch table, the table is compressed and the value of TNES is adjusted to reflect the number of entries currently in the table. Cflag is a binary flag set non zero when a byte source needs to be computed.

FIG. 3 is a listing of Variables, Counters and Pointers which are associated with a processing pass through data in an I/O Buffer.

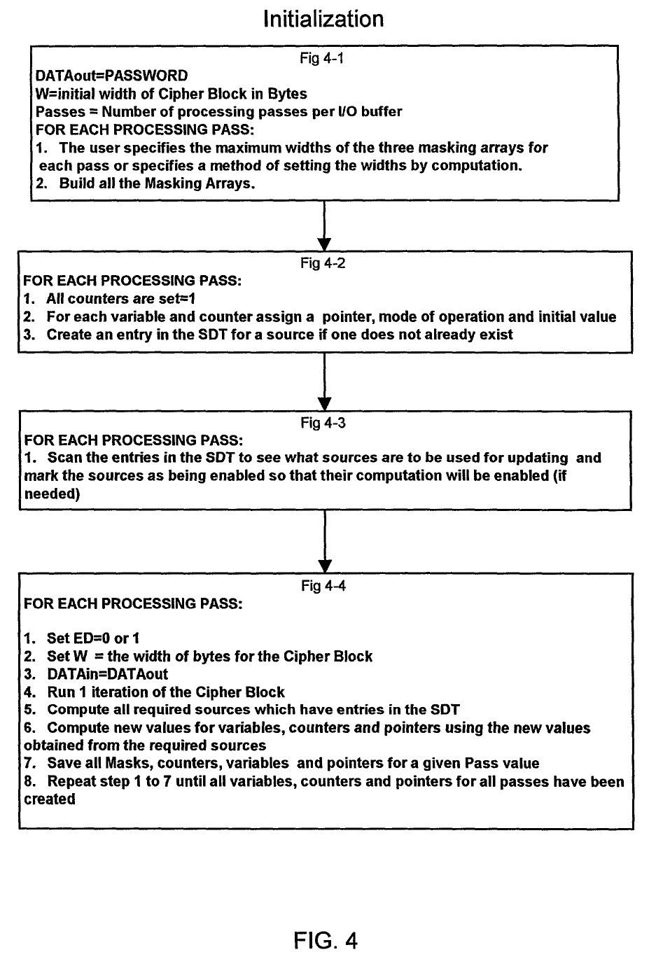

FIG. 4 is a flowchart for initializing the scheme for either encryption or decryption. This initialization is based upon the assumption that the scheme will be used to create all of the needed control variables, counters, sources and pointers. Otherwise, the needed variables, counters, sources and pointers can be built directly by sampling a repeatable digital source or through the use or any combination of sampling and or computation. But for this illustration, it will be assumed that the scheme described herein will be used. Initially, at step 4-1, the user specifies the initial width, W, of the cipher block in bytes, the number of processing passes to be initialized and an initial password which consists of W bytes which will be used to form the data item DATAout. Next the masking arrays M(1), M(2) and M(3) are created from sampled sources. At step 4-2, and all counters will be set equal to 1 for the required number of processing passes, and sources, pointers and addressing modes are assigned for all variables and counters. In addition, all required sources have their Relative Source Number, RN, entered into the Source Dispatch Table along with the corresponding Byte Source Number, SN (see FIG. 2). Step 4-3 consists of scanning the SDT entries to determine which sources will be needed to initialized for each processing pass. And at Step 4-4, The user sets ED=0 or 1 (this is independent of whether the scheme will be encrypting or decrypting). Next DATAin is set equal to the password in DATAout. One iteration of processing with the cipher block is performed. Next all required byte source values are computed and since all counters were set equal to 1 then the counters all are decremented to zero and the process then updates all variables, counters and pointers from the computed byte sources. This process is repeated for all processing passes requiring initialization.

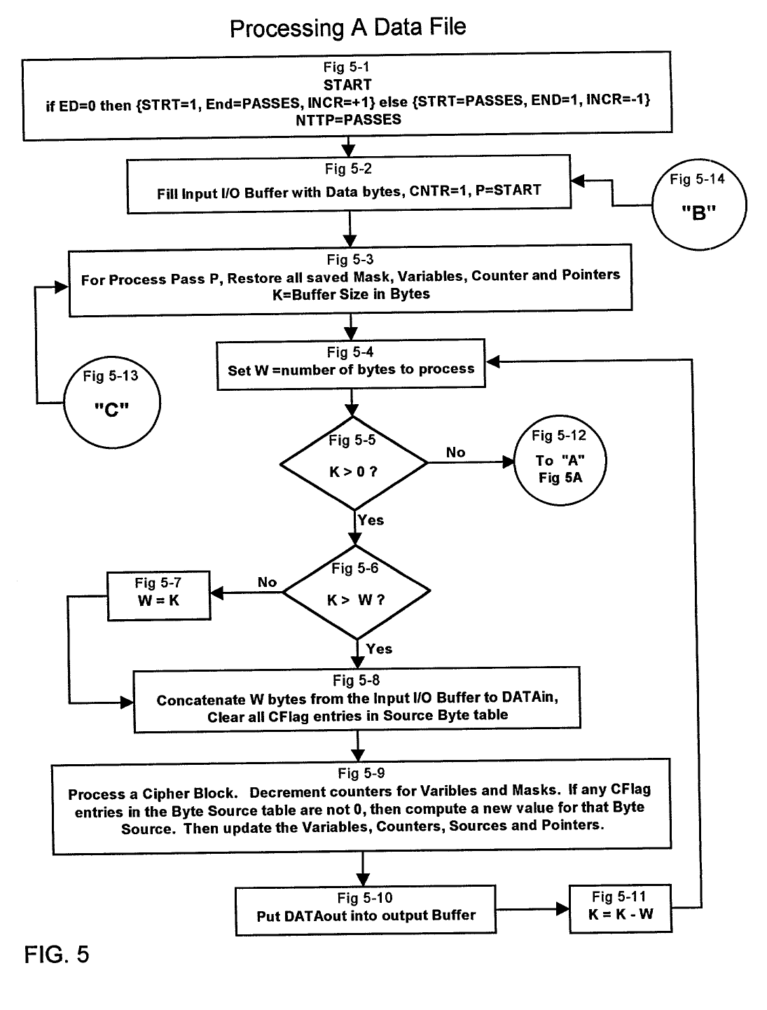

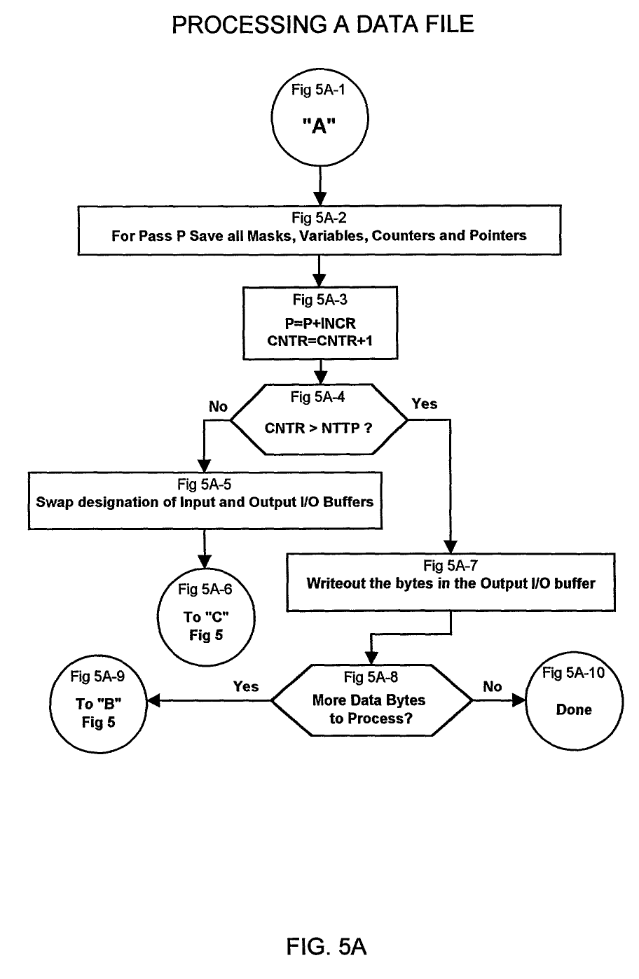

FIG. 5 and FIG. 5A are flowcharts of the steps for processing a data file. Starting at Step 1 on FIG. 5., NTTP is set equal to Passes, the number of processing passes to be performed. When ED=0, the starting pass number STRT is set equal to 1, the incrementing value INCR is set equal to 1 and the ending pass number END is set equal to PASSES. Thus for each I/O Buffers worth of data bytes, the passes will be sequentially accessed from 1 to PASSES. When ED=I, the starting pass number is PASSES, the incrementing value is −1 and the end pass number is 1 enabling the passes to be counted backwards from PASSES to 1. At step 5-2 the input I/O buffer is filled with data bytes and the counter, CNTR, is set equal to 1 and the variable P is set equal to STRT. P is used to designate which pass number is being processed. At step 5-3 for pass P, all previously saved masks, variable, counters, pointers, etc. are restored and the counter K is set equal to the number of bytes in the Input I/O Buffer. At step 5-4, W is set equal to the number of bytes to be presented to the cipher block. At step 5-5, if K>0 is true, then there are more bytes to be processed for this I/O buffer and we proceed to step 5-6, otherwise if K<=0, the next step is 5-12 which goes to FIG. 5A step 1. Assuming that the 1/0 buffer has not been completely processed, hence K>0 is true, then at step 5-6 we test to see if there are at least W bytes left in the buffer. If K>W is true, we proceed directly to step 5-8 else if W <=K, then we proceed to step 5-7 where W is set equal to K (the number of bytes left) and then we proceed to step 5-8. At step 5-8 the W bytes from the Input I/O buffer are concatenated to form a single W byte width DATAin element, all source flags are cleared, indicated that no source values need to be computed and then we proceed to step 5-9. At step 5-9 the W bytes in the DATAin element are processed, all counters are decremented and if any counters equal zero, the sources associated with the counter and it's variable will have the Cflag entry flag set indicating that the source needs to be computed. At the end of decrementing the counters. All required byte sources which have their Cflag set are computed and the counters are reset to a non zero value and the associated variables or mask are updated. The next step is 5-10 where the W bytes in DATAout element are either directly written to the Output I/O Buffer or decatenated and put into the Output I/O buffer in a permuted manner. From step 5-10, then next step is 5-11 where K is incremented by W (K equal the number of bytes processed so far) and then the scheme loops back to step 5-4 to continue the process. From before, when all the bytes in the I/O buffer have been processed we go via step 5-12 to step 5A-1 then to step 5A-2. At step 5A-2 all masks, variables, counters and pointers are saved. We then proceed to the next step 5A-3 where P is incremented by INCR (the pass number is either incremented or decremented by 1) whereupon P then represents the pass number for the next pass to be processed. Also CNTR is incremented by 1. CNTR is used as a loop counter. From step 5A-3 the scheme proceeds to step 5A-4 where CNTR is compared to NTTP (Number of Times To Process). if CNTR>NTTP is true, then the buffer has been completely processed and we proceed to step 5A-7 where the contents of the Output I/O Buffer is written out. At step 5A-4, if CNTR is not greater than NTTP, then we go to step 5A-5. At step 5A-5, the designations for the Input and Output I/O Buffers are exchanged. From step 5A-5 we proceed to step 5A-6 which goes to “C” on FIG. 5, and thus to step 5-3 where another processing pass is initialized. Going back to step FIG. 5A-7, when the data has been written out we go to step 5A-8 to see if there is any more data to be processed. If not, then the processing sequence ends at step 5A-10, other wise 5A-8 goes to 5A-9 which goes back to “B” on FIG. 5. and thus to step FIG. 5-2 to initialize the processing of a new buffer of data to be processed.

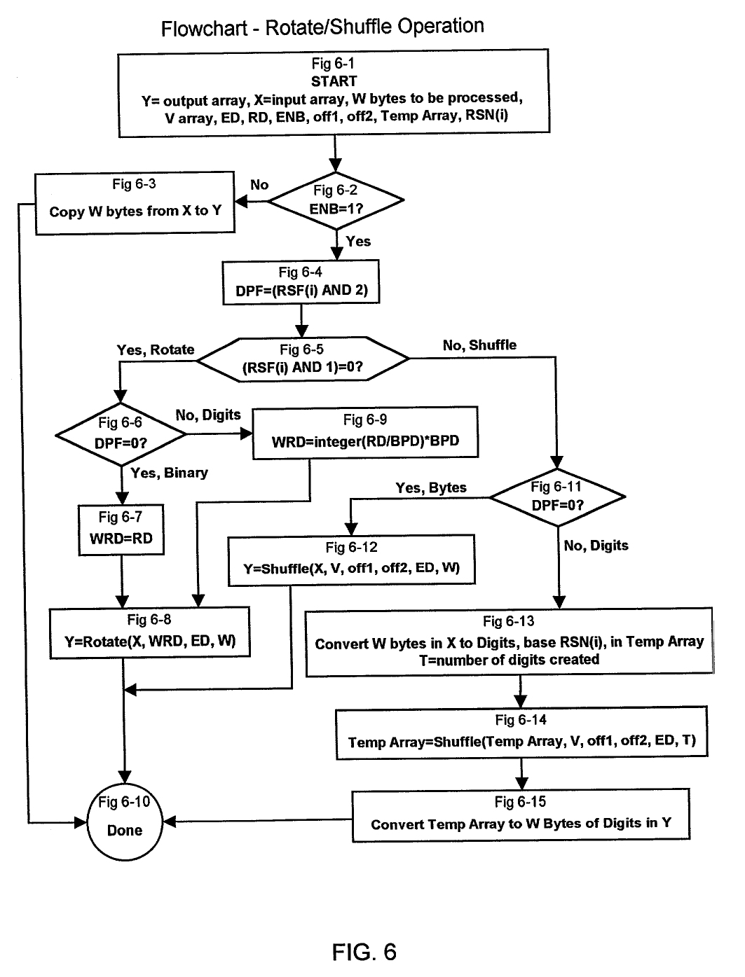

FIG. 6. is a flowchart of the Rotate/Shuffle operation. X is an array or string of input bytes, while Y will contain an array or string of output bytes at the end of the procedure. V is an array of arbitrary bytes, ED is the Encrypt/Decrypt flag and has a value of 0 or 1, RD is a signed number representing the number of bits to be rotated (a positive number is left, while a minus number is right). ENB is a binary flag, 0=disable and 1 =enabled, used to disable or enable the Rotate/Shuffle operation. When ENB=0, the W bytes from X are copied unchanged to Y. When ENB=1, either the Rotate or Shuffle operation is performed. Off1 and off2 are two byte arbitrary values used to modify the computations for shuffling the sequence of bytes. TEMP array is a temporary array of bytes, used to hold digits for a shuffle sequence using digits instead of whole bytes. RSN(i) is the number base to be used if the W bytes are to be converted to digits before shuffling. The value of RSN(i) should divide into (W times the bit width of the bytes) without remainder so as to prevent overflow when reconverting back to binary values.

From Step 6-1 we proceed to step 6-2 where the ENB binary flag is checked. If ENB=0 then the Rotate/Shuffle operation is disabled and the W bytes in X are copied, at step 6-3, unmodified to Y. On the completion of the copying, the process proceeds to step 6-10 to exit. Now when ENB=1, the next step is 6-4, where DPF is computed. DPF (Digit Process Flag)=(RSF(i) AND 2) and is either 0 or 2 in value. The next step, 6-5, tests the least significant bit of RSF(i). If (RSF(i) AND 1)=0 then the operation to be performed will be ROTATION otherwise a SHUFFLE operation will be performed. If the result of the test at step 6-5 is true, we proceed to step 6-6 (rotation) and test the value of DPF. At 6-6 if DPF=0 is false then we go to step 6-9 (for rotating digits) otherwise the step executed after 6-6 is step 6-7 where WRD is set equal to the value of RD. WRD is the Working RD value. From step 6-7 the next step is 6-8 where a new value of Y is created by rotating the W bytes of X, WRD bits. If at step 6-6 DPF was not 0, then at step 6-9 WRD is computed to be the number of bits needed to rotate whole digits. The integer part of RDIBPD where BPD is the number of Bits Per Digit represent the number of digits which can be rotated based upon the value of RD. Next the integer is multiplied by BPD to create a rotate distance which is now an integer number of digits in value. Then this computed WRD value is used at step 6-8 to rotate the W bytes in X to form a new value for Y. If at step 6-5 the answer was false then step 6-11 is executed next. Here DPF is checked to see if it is equal to 0. If DFP=0 is true then whole bytes are shuffled and step 6-12 is executed next. And from step 6-12 the sequence ends at step 6-10. However if At step 6-11 DPF=0 is false, the step 6-13 is the next one in sequence. Here the W Bytes from X are converted to digits, base RSN(i). This is accomplished by repeated division of X by RSN(i) and using the remainders as digits which are then stored in the TEMP array. The total number of TEMP array entries used, is saved in T which is then used at step 6-14 in the shuffle operation. If RSN(i) is a power of 2 in value, then the number of bits represented by BPD=RSN(i))/ln(2) is effectively shifted out of X to form the entries in Temp Array. One X is converted to T digits at step 6-13, the T bytes in the Temp Array, containing these T digits, are shuffled at step 6-14. Then these T digits contained in the Temp Array are converted back into an array of bytes or a string Y at step 6-15. This conversion is accomplished by either shifting the BPD bits from each TEMP Array entry to form Y or by sequentially multiplying and adding. This latter method sets Y=0, initially, then repeatedly multiplying Y by RSN(i) and adding a digit from Temp Array to Y in sequence (starting from the most significant digit). When completed, Y contains W bytes which have been shuffled in BPD units. From step 6-15, step 6-10 is executed to exit.

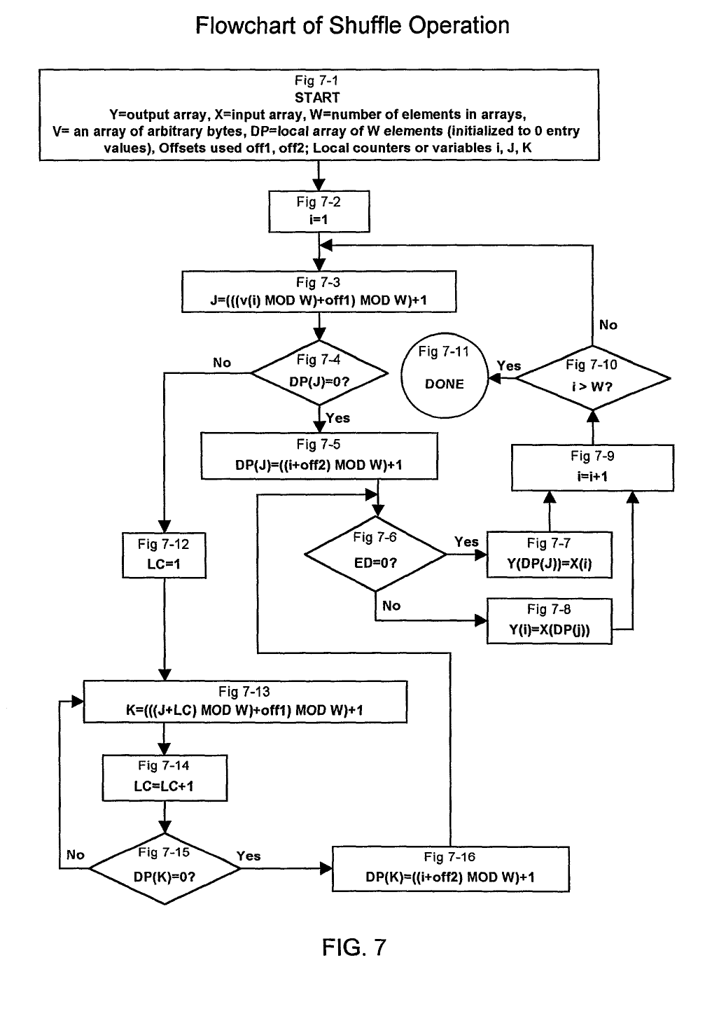

FIG. 7 is a flowchart of the shuffle operation. X is an array or string containing bytes; to be shuffled, while Y is the resulting string or array containing the results of the shuffle operation and V is an array or string of arbitrary bytes. W designates the number of bytes to be shuffled. The local array DP (W bytes long) is initialized to all 0's. If the scheme is modified to allow index value of 0 then DP should be initialized to -1 or some unused index value. From step 7-1 the procedure goes to step 7-2 where the variable i=1 is initialized (as a local counter). Offsets off1 and off2 are arbitrary bytes used to provide additional degrees of variability to the process. At step 7-3 the variable J is computed. J=((v(i) Mod W)+off1) MOD W)+1 computes a pointer or index (counting from 1 to W). At step 7-4 the value of DP(J) is checked to see if it is equal to 0. If DPO)=0 then the Jth entry of DP has not been previously used so it can contain a shuffled index value. Assuming DP(J)=0 we then go to step 7-5 where a new index value for DP(J) is computed, DP(J)=(i+off2 ) MOD W)+1. Next at step 7-6 the value of ED is checked. If ED=0, we go to step 7-7 where (en. crypting) the Y(DPO))=x(i), otherwise if ED=1, we proceed to step 7-8 where Y(i)=X(DP(J)). Next at step 7-9, the variable i is incremented then at step 7-10, i is compared to W. If i is greater than W the operation is done and we proceed to step 7-11 to exit. However, if at step 7-10, i is less than or equal to W we proceed back to step 7-3 to continue the process. If at step 7-4, the value of DP(J) is not 0, indicating that it has already been used, we then go to step 7-12, there LC is set equal to 1. LC is used as a local counter value. From Step 7-12 we proceed to step 7-13 where K is computed, such that K=(((J+LC) MOD W)+off1) MOD W)+1. Next at step 7-14, LC is incremented by 1 under the assumption that it may be needed again, and then at step 7-15 the value of DP(k) is tested. At 7-15 if DP(K)=0 is false indicating that the slot DP(K) has again been used, we go back to step 7-13 and again compute a new value of K. When at step 7-15, DP(K)=0 is true, indicating, an unused index value, we proceed to step 7-16 and compute a new value for DP(K). At step 7-16, the new value for DP(K)=((i+off2 ) MOD W)+1 is computed. Then from either step 7-16 we proceed back to step 7-6.

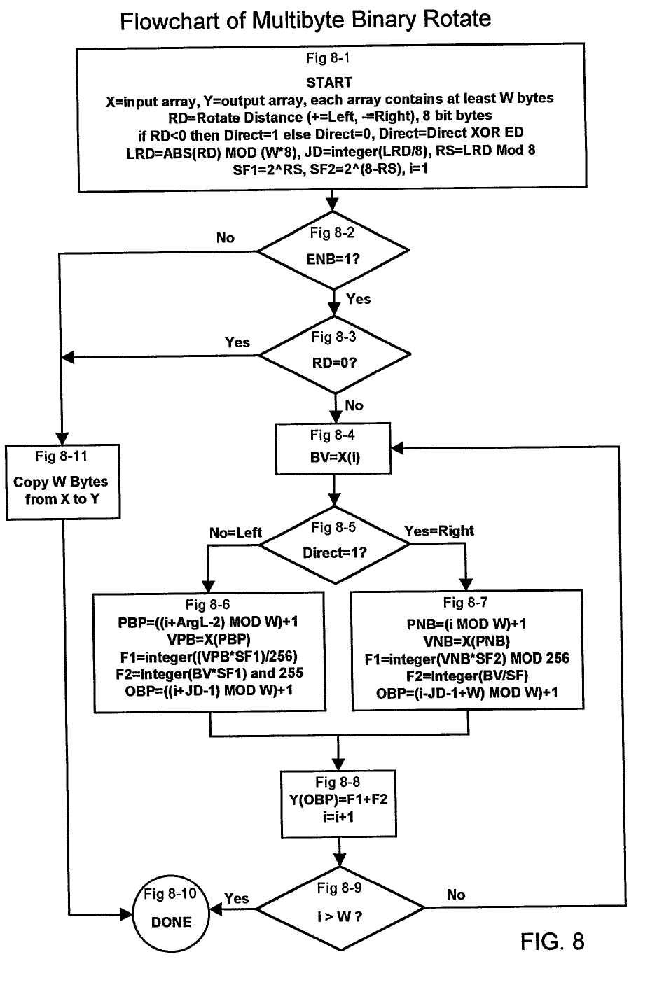

FIG. 8 is a flowchart of a multibyte binary rotate operation. This flowchart is based upon the assumption that a byte is made up of 8 bits. Other bits widths may be used with the appropriate changing of some constants. At step 8-1, X is an input array or string, Y contains the resulting output string or array, both W bytes in size. RD is a variable indicating the bit distance to be rotated. if RD<0 (right rotate) then Direct=1 else RD >0, (left rotate) then Direct=0. ED is a 1 bit binary flag indicating whether encryption, ED=0, or decryption will occur. ENB is a 1 bit flag indicating whether the rotate operation is enabled. When disabled, the resultant Y string or array is equal to the initial X string or array. Direct is a 1 bit flag equal to the direction to be rotated. if Direct=0 the direction is left, otherwise if Direct=1, the direction is right. Note ED is xor'd with the initial value of Direct. This results is a reversal of the direction or rotation when ED=1 and compared to when ED=0 . LRD=ABS(RD) MOD W*8, were LRD is the Local Rotate Distance while JD=integer of (LRD/8). JD, Jump Distance, is the number of bytes to be jumped from the present location and is where the output of the local byte will reside as a result of the rotation. RS=LRD MOD 8, is the residual shift value or the distance within a byte that needs to be shifted. SF1 and SF2 are values which are used to compute the shifted bit patterns and will be described in more detail below. These variables are defined as follows: SF1=2^{RS} while SF2 =^{8-Rs}. The variable i is local variable used as a loop counter. From step 8-1 we proceed to step 8-2. At step 8-2 if ENB=0, the rotate operation is disabled and we proceed to step 8-11, where the W bytes are copied (unchanged) from X to Y. Then from step 8-9 we proceed to step 8-10 to exit. Now, if at step 8-2, ENB=1, we proceed to step 8-3. Here if RD=0 is true, we proceed again to step 8-11, otherwise we proceed to step 8-4. At Step 8-4, BV=X(i), where BV is the value of the ith byte in X. Next at step 8-5, the direction flag is tested. If Direct=1 is false (left rotate), then we go to step 8-6. At step 8-6, several pointers and variable are computed. PBP (Previous Byte Pointer) is computed to point to the byte to the right of the present on pointed to by i. VPB is the Value of the Previous Byte. F1 is equal to the bits being shifted left from the previous byte to the present byte, while F2 is equal to the bytes remaining in the present byte after it is shifted left. OBP is the Output Byte Pointer and designates where the resulting new byte value will be placed. From step 8-6 we proceed to step 8-8 where Y(OBP)=F1+F2 . Additionally the variable i is incremented by 1 at step 8-8. From 8-8 we proceed to step 8-9 where i is compared to W. If i>W is true, we proceed to step 8-10 to exit, otherwise we go back to step 8-4 to continue processing additional bytes. If at step 8-5, Direct=1 is true, then we have a right rotate and proceed to step 8-7 instead of step 8-6. At step 8-7, several variable and pointers are computed. PNB, Pointer to Next Byte, is compute to point to the byte to the logical right of the present byte designate by i. VNB is the value of the byte pointed to by PNB. F1 is a variable containing the bits remaining in the lower end of the VNB after shifting right. F2 is a variable containing the bits in the present byte which are shifted right into the i next byte. Again OBP is a pointer indicating where the resultant new byte will be placed in Y. From step 8-7 we again proceed to step 8-8 where the output byte Y(OBP) is created by summing F1+F2 . And as from before i is incremented and we proceed to step 8-9.

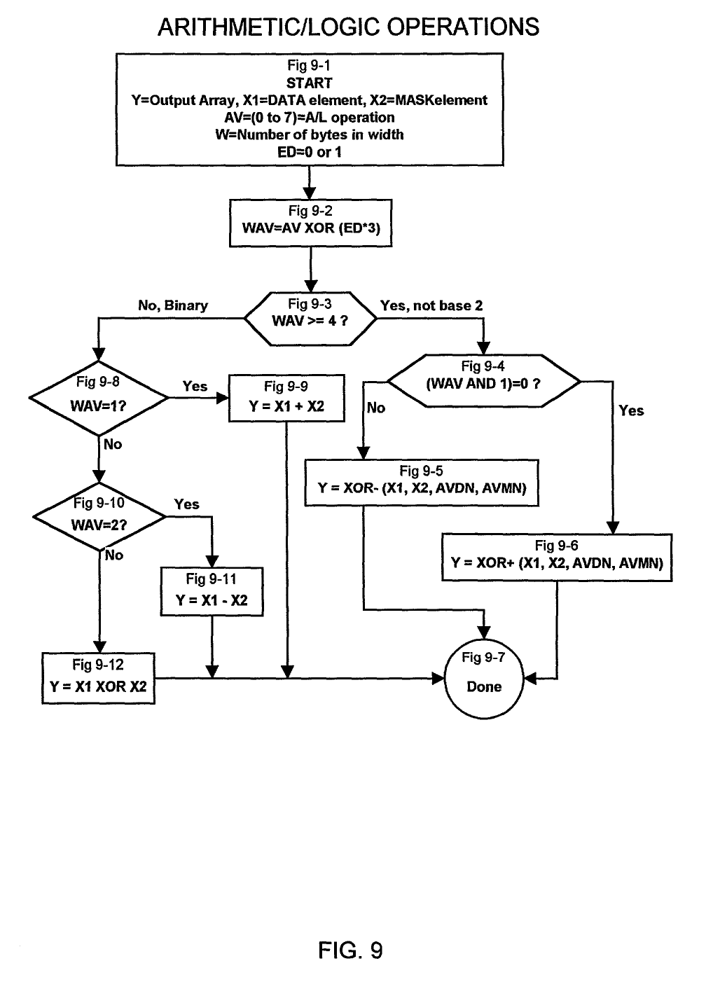

FIG. 9 is a flowchart of the arithmetic/logic operations. At step 9-1, Y is the output array or string, X1 is the input array or string, X2 is W bytes from a masking array, AV is a 3 bit value designating the A/L operation to be performed, W designated the number of bytes to be processed and ED is a 1 bit flag. ED is set 0 for encryption, and set equal to 1 for decryption. From step 9-1 we proceed to step 9-2. At 9-2 , WAV is set equal to AV XOR (3 *ED). Hence when ED=0, WAV=AV and when ED=1, WAV=AV with the lower 2 bits complemented. At step 9-3 the value of WAV is checked. If WAV>=4 is true, then we go to step 9-4 to perform a non base 2 computation. At step 9-4, if WAV AND 1=0 is true then Y=XOR+(X1, X2 ) at step 9-6, otherwise we proceed to step 9-5 and set Y=XOR−(X1, X2 ). From either step 9-5 or step 9-6 we proceed to step 9-7 to exit. At Step 9-5 or 9-6, AVDN and AVMN represent the number bases which are to be used when converting the data, X1, and mask, X2 , elements into digits to be combined using either XOR+, step 9-6, or XOR−, step 9-5, operations. If at step 9-3 WAV>=4 was false, then we have binary operations and proceed to step 9-8. If at step 9-8, if the test WAV=1 is true then we procees to step 9-9 where Y=X1+X2 and then to step 9-7 to exit. If at step 9-8 the test was false, then we proceed to step 9-10 and if the test WAV=2 is true we proceed to step 9-11 where Y=X1−X2 and again then to step 9-7 to exit. If the test at step 9-10 was false, we proceed to step 9-12 where Y=X1 XOR X2 and then finally to step 9-7 to exit.

FIG. 10 is a flowchart of the steps used to update the bytes in a mask array or string. Steps 10-1 through 10-4 are used to create a string or array of W bytes in TEMP which will be used to update the lower W bytes of mask array M(i). Similarly, Steps 10-5 through 10-7 are used to modify the mask array M(i) prior to its being updated by TEMP. While steps 10-8 through 10-12 are those concerned with the modification of M(i) by TEMP.

At Step 10-1, W bytes from the source/pointer MUP(i) are copied to the string or array TEMP. At step 10-2, the binary flag MURSF, Mask Update Rotate/Source Flag, is tested to see if it's value is equal to zero. If this condition is true, the next step used is step 10-3 designating a rotate of TEMP, otherwise, step 10-4 is used which specifies a shuffle of the bytes in TEMP. At Step 10-3, the binary bits in the W bytes in TEMP are rotated by the distance specified by the variable MURV(i). While at step 10-4, W bytes from the source/pointer MUVARP(i) are copied to V. Where V is a string or array, W bytes long, of arbitrary bytes which is used in the computation of addressing for the shuffle operation. Similarly, MUoff1 and MUoff2 are also used in the computations of the shuffle operation. At the completion of either step 10-3 or step 10-4, TEMP contains W bytes which are used to update the lower W bytes of M(i) as described below.

At Step 10-5 the binary flag MRSF, Mask Rotate/Shuffle Flag, is tested to see if it's value is equal to zero. If this condition is true, the next step used is step 10-6 which designates a binary rotation of the ML(i) bytes of M(i). If the test condition at step 10-5 is false, then we proceed to step 10-7 to shuffle the ML(i) byte of M(i). At step 10-6, MRV(i) specifies the direction and distance of the binary rotation of M(i). At step 10-7, W bytes form the source/pointer MVARP(i) are copied to V. Then the ML(i) byte of mask M(i) are shuffled using V, Moff1 and Moff2 during the computation of the shuffling indexes. After the completion of either step 10-6 or step 10-7 we proceed to step 10-8. Here, at step 10-8, we test the value of MAV(i). If MAV(i)=1 is true we proceed to step 10-0, otherwise to step 10-9 to continue examining the value of MAV(i). At step 10-9 if MAV(i)=2 is true we proceed to step 10-11, otherwise we proceed to step 10-12. At step 10-10, the lower W bytes or M(i) are modified by adding the W bytes of TEMP to them. At step 10-11, the lower W bytes of M(i) are modified by subtracting the W bytes of TEMP to them and at step 10-12, the lower W bytes of M(i) are modified by xoring the W bytes of Temp to them. At the completion of steps 10-10, 10-11 or 10-12 we proceed to step 10-13 to exit.

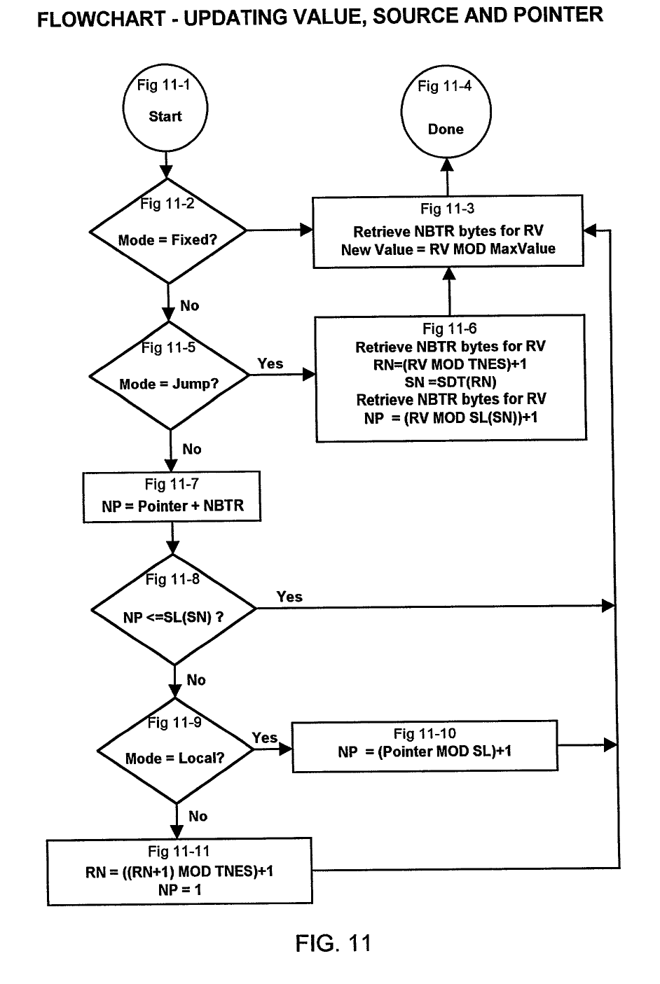

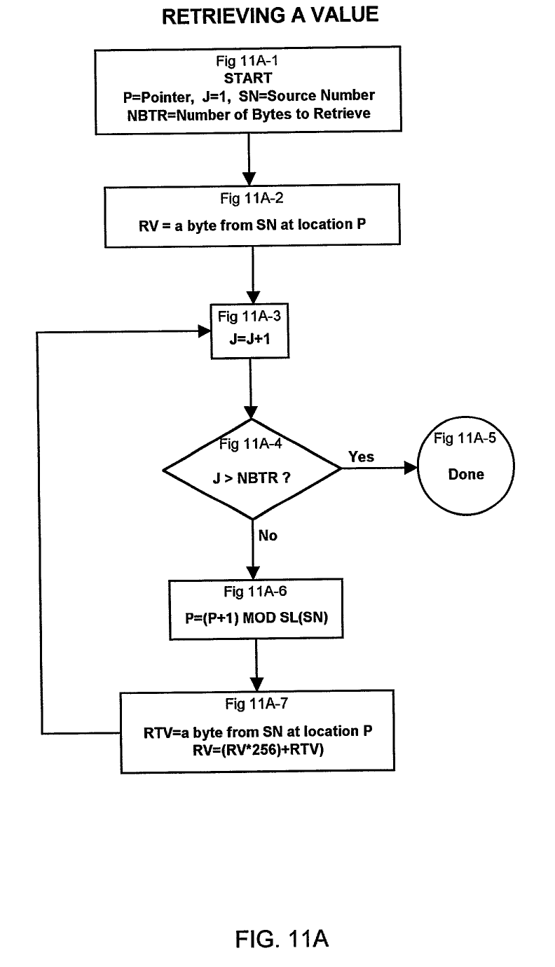

FIG. 11 is a flow chart of the retrieval of a value using a source and pointer. This figure shows details about the various address modes and how these mode affect the selection or updated source and pointer values. When a counter is decremented to zero, the counter value, the variable associated with that counter will both need to be updated. Associated with a counter or variable is a source, pointer and addressing mode information (see FIGS. 2 and 3). Starting at step 11-1, we proceed to step 11-2 where the address mode for the variable or counter under selection is checked. If the MODE=FIXED is true, we proceed to step 11-3, otherwise we proceed to step 11-5 for further mode checking. At step 11-5, if MODE=JUMP is true then we proceed to step 11-6 otherwise we proceed to step 11-7. If MODE=FIXED is true at step 11-2, we go to step 11-3. Here, using the present designated source and pointer for the counter or variable being updated, NBTR (Number of Bytes To Read) bytes are retrieved from the source (see FIG. 11A for details) and the retrieved value is placed in RV. Each counter and variable may have a maximum value associated various categories of items being updated and if this is implemented then New Value=RF MOD MaxValue, where MaxValue is chosen so that it will limit the size which New Value as desired by the user. Since we are in FIXED MODE, the source and pointer values are unchanged and we proceed to step 11-4 to exit. If at step 11-5, the test MODE=JUMP is true, we proceed to 11-6 where a new relative source number, NSN, and new pointer, NP, references are created. Each source has a relative number associated with the definition of the source (see FIG. 2). The returned NSN becomes the RN for the variable or counter being updated. The variable TNES is the Total Number of Enabled Sources available at the present time the pointers and sources are being updated. SL, Source Length, is the maximum length in bytes which a pointer may have for a particular source. If the addressing mode is not either fixed or jump mode, we go from step 11-5 to step 11-7. Here, a new pointer value, NP, is created by adding NBTR to the present pointer value. Next at step 11-8, the value of NP is compared to the source length for source number SN. If NP<=SL(SN) then the present value of NP is used and we got to step 11-3 to obtain a New Value to be used to update a counter or variable, etc. If however, NP is>SL(SN), then we proceed to step 11-9 because the NP no longer points within the present source length SL(SN). How the value of NP is corrected to point to a location within a source is dependent upon the addressing mode. If, at step 11-9, the condition Mode=Local is true, meaning the pointer always stays within the same source, then we proceed to step 11-10 then the pointer value NP is corrected to fit within the present source. If at step 11-9, the condition Mode=Local is false, meaning that we are in General Mode, then we need to set NP=1 and RN is incremented to point to the next RN entry.

FIG. 11A is a flow chart of a routine used in step 11-3 and 11-6 (FIG. 11) to obtain a value RV. At Step 11A-1, P is a byte pointer into a source, SN, where SN=SDT(RN) and NBTR is a small integer equal to the number of bytes to be retrieved from the source which will be used to form the value RV. The local counter, J, is set equal to 1. At Step 11A-2 , RV=a retrieved byte. At step 11A-3, J is incremented by 1. And at step 11A-4, J is compared to NBTR. It J>NBTR is true, then we go to step 11A-5 to exit, with RV being the final Retrieved Value. If, the condition tested was false, indicating that there are additional bytes which need to be retrieved, the we go to step 11A-6. At step 11A-6, the pointer P is incremented (modulo the source length) and then at step 11A-7, the variable RTV, Retrieved Temporary Value, is a byte retrieved from SN at P using the updated value of P. Assuming that we are dealing with an 8 bit byte, then the present value of RV is multiplied by 256 and then RTV is added to it to form a new value for RV. and from step 11A-7 we go back to step 11A-3 to repeat the process.

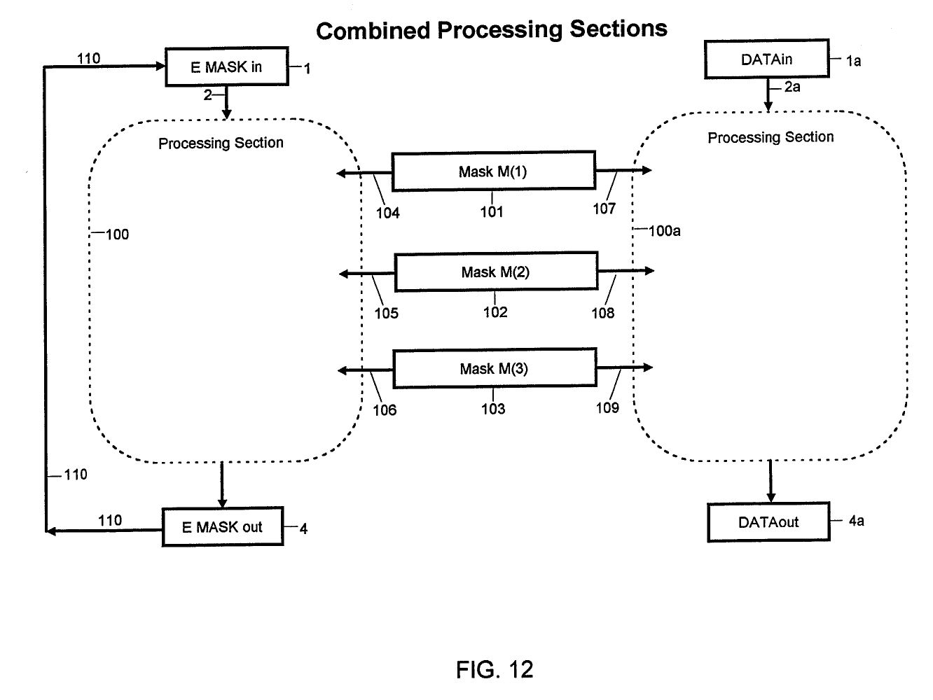

FIG. 12 is a diagram showing two processing sections, 100 and 100a, combined by having common mask elements M(1 to 3). Processing section 100 is used to control and process an initial password value, E MASK in, 1, resulting in E MASK out, 4. Upon the completion of the processing, E MASK out, 4, is copied back via 110, and becomes a new value for E MASK in, 1. In a similar fashion, data to be encrypted or decrypted is put in DATAin, 1a, and processing using 100a, resulting in DATAout, 4a. The processing of the two section is synchronized so that section 100a is run only after 100 has completed processing. The processing sections within section 100a do not update or change any of the mask elements M(1 to 3). These are changed only by section 100, providing change in mask elements for processing section 100a. In another method, not shown, the input or output data elements from addition processing sections are used to provide information to control or modify the data being processed by section 100a.

What is claimed is:

1. Encryption/Decryption apparatus comprising:
means for retrieving information to be encoded/decoded, said information defining an array D1 of first elements,
means for combining of the first elements of D1 by concatenation of at least one to another of said first elements of D1, wherein said concatenation results in formation second elements of an array D2, and wherein the number of second elements is less than the number of first elements, but where at least one of the second elements is larger than at least one of the first elements,
means for converting at least one of the second elements of D2 into digits D3, base N1,
means for modifying the digits D3, and
means for reconverting the modified digits D3 back, using number base N1, into an element of D2
means for converting and decatenating said modified second elements of array D2 back into the first elements of D1, and
an array of R elements, said R elements arranged to provide information for directing and controlling one or more above elements of means for: combining, converting, modifying, converting the modified digits, and converting and deconcatenating.

2. The apparatus as defined in claim 1 further comprising means for permuting the order of said first and second elements being concatenated, rotated, modified, shuffled, converted and decatenated.

3. The apparatus as defined in claim 1 further comprising an array S wherein said array S is arranged to provide information, in addition to array R, for directing and controlling one or more elements of means for: combining, converting, modifying, converting the modified digits, and converting and deconcatenating.

4. Apparatus as defined in claim 1 wherein said means for combining comprises:
means for arithmetic and logic combining selected from the group consisting of means for adding, subtracting, exclusive-oring, rotating, shuffling of sequence, or using a modified exclusive-or base N function.

5. Apparatus as defined in claim 4 where in said means for arithmetic and logic combining comprises means for converting into another number base.

6. Apparatus as defined in claim 1 wherein the number of first elements, D1, concatenated to form each element of array D2 is varied in number.

7. A method for encryption/decrypting comprising the steps of:
retrieving information to be encoded/decoded, said information defining an array D1 of first elements,
combining of the first elements of D1 by concatenation of at least one to another of said first elements of D1, wherein said concatenation results in formation second elements of an array D2, and wherein the number of second elements is less than the number of first elements, but where at least one of the second elements is larger than at least one of the first elements,
converting at least one of the second elements of D2 into digits D3, base N1, modifying the digits D3, and
reconverting the modified digits D3 back, using number base N1, into an element of D2
converting and decatenating said modified second elements of array D2 back into the first elements of D1, and
arranging an array of R elements to provide information for directing and controlling one or more of above steps of: combining, converting, modifying, converting the modified digits, and converting and deconcatenating.

8. The method as defined in claim 7 further comprising the step of permuting the order of said first and second elements being concatenated, shuffled, rotated, modified, converted and decatenated.

9. The method as defined in claim 7 further comprising the step of arranging an array S containing information, in addition to array R, for directing and controlling one or more elements of above steps of: combining, converting, and modifying.

10. The method as defined in claim 7 wherein said step of combining comprises the steps of:
arithmetic and logic combining, wherein the arithmetic and logic steps are selected from the group consisting of the steps of adding, subtracting, exclusive-oring, rotating, shuffling, sequencing or using a modified exclusive-or base N function.

11. Method as defined in claim 10 wherein said arithmetic and logic combining comprises converting into another number base.

12. Method as defined in claim 7 wherein the number of first elements, D1, concatenated to form each element of array D2 is varied in number.

13. Encryption/Decryption apparatus comprising:
means for retrieving information to be encoded/decoded, said information defining an array D1 of first elements expressed in a number base M,
first means for converting each of said first elements into an array D3 of third elements d3 expressed in a number base N1, wherein N1 is greater than two,
means for retrieving fourth elements d4 of an array, D4, wherein said fourth elements are expressed in said number base N2,
means for combining at least one of the elements d3 of D3 with at least one of the elements d4 of array D4, according to the relationship d3 (XOR+) d4, thereby forming fifth elements of an array D5, and
second means for converting the elements of D5, base N1, into an array of such elements, D6, expressed in a number base M wherein the array D6 is the ciphertext of D1 when encrypting and wherein array D6 is the plaintext when decrypting.

14. Apparatus as defined in claim 13 wherein said means for combining is governed by the relationship, d3 (XOR−) d4, thereby forming fifth elements of an array D5.

15. Apparatus as defined in claim 13 wherein the number of first elements, D1, concatenated to form each element of array D2, is varied in number.

16. A method for encrytion/decryption comprising the steps of:
retrieving information to be encoded/decoded, said information defining an array D1 of first elements expressed in a number base M,
converting each of said first elements into an array D3 of third elements d3 expressed in a number base N1, wherein N1 is greater than two,
retrieving fourth elements d4 of an array, D4, wherein said fourth elements are expressed in said number base N2,
combining at least one of the elements d3 of D3 with at least one of the elements d4 of array D4, according to the relationship d3 (XOR+) d4, thereby forming fifth elements of an array D5, and
converting the elements of D5, base n1, into an array of such elements, D6, expressed in a number base M wherein the array D6 is the ciphertext of D1 when encrypting and wherein array D6 is the plaintext when decrypting.

17. The method as defined in claim 16 wherein the step of combining at least one of the elements d3 of D3 with at least one of the elements d4 of D4, according to the relationship d3 (XOR−)d4, thereby forming fifth elements of an array D5.

18. The method as defined in claim 16 wherein the number of first elements, D1, concatenated to form each element of array D2, is varied in number.
